(19) United States
(12) Patent Application Publication
(10) Pub. No.: US 2019/0315342 A1
(43) Pub. Date: Oct. 17, 2019

(54) PREFERENCE ADJUSTMENT OF AUTONOMOUS VEHICLE PERFORMANCE DYNAMICS

(71) Applicant: GM Global Technology Operations LLC, Detroit, MI (US)

(72) Inventors: Gary P. Bertollini, Lake Orion, MI (US); Joseph F. Szczerba, Grand Blanc, MI (US); Roy J. Mathieu, Rochester Hills, MI (US)

(21) Appl. No.: 15/952,704

(22) Filed: Apr. 13, 2018

(51) Int. Cl. B60W 30/02; G05D 1/00

(52) U.S. Cl. CPC B60W 30/025; H04W 4/40; G05D 2201/0212; G05D 1/0088

(57) ABSTRACT

Embodiments include methods, systems and computer readable storage medium for adjusting ride and/or performance dynamics of a passenger transport. The method receiving, by a processor, a transportation request. The method further includes assigning, by the processor, a passenger transport to fulfill the transportation request. The method further includes receiving, by the processor, at least one passenger profile, wherein the at least one passenger profile includes preferred ride and performance dynamics for a passenger. The method further includes adjusting, by the processor, one or more ride and performance dynamics for the passenger transport in response to the received at least one passenger profile. The method further includes transporting, by the passenger transport, one or more passengers associated with the transportation request to a destination.

### INTRODUCTION

The subject disclosure relates to rideshare services, and more specifically to dynamically adjusting ride and performance dynamics of an autonomous vehicle.

Real-time ridesharing (also called dynamic, on-demand or instant ridesharing) is an automated service that matches drivers and users requesting one-way ridesharing services on very short notice. Real-time ridesharing (ridesharing) typically employs some form of navigation services/devices, applications for drivers to receive notifications for passenger pickup and applications for users to request ridesharing services. Ridesharing functionality in light of new technologies, for example, autonomous vehicles, are increasingly being considered.

Autonomous vehicles are automobiles that have the ability to operate and navigate without human input. Autonomous vehicles use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles increasingly communicate with remote computer systems and with one another using V2X communications (Vehicle-to-Everything, Vehicle-to-Vehicle, Vehicle-to-Infrastructure).

Accordingly, it is desirable to provide a system that can allow a passenger or group of passengers to directly or indirectly adjust ride and/or performance dynamics of an autonomous vehicle. Adjustments of the autonomous vehicle by the passenger(s) can occur in an effort to optimize a personal riding experience.

### SUMMARY

In one exemplary embodiment, a method for adjusting ride and/or performance dynamics of a passenger transport is disclosed. The method includes receiving, by a processor, a transportation request. The method further includes assigning, by the processor, a passenger transport to fulfill the transportation request. The method further includes receiving, by the processor, at least one passenger profile, wherein the at least one passenger profile includes preferred ride and performance dynamics for a passenger. The method further includes adjusting, by the processor, one or more ride and performance dynamics for the passenger transport in response to the received at least one passenger profile. The method further includes transporting, by the passenger transport, one or more passengers associated with the transportation request to a destination.

In addition to one or more of the features described herein, one or more aspects of the described method can additionally be related to receipt of input from the one or more passengers during transport to the destination and adjusting the one or more ride and performance dynamics for the passenger transport in response to the received input. Another aspect of the method can include monitoring an anxiety and/or comfort level for the one or more passengers during transport to the destination and adjusting the one or more ride and performance dynamics for the passenger transport in response to the monitored anxiety and/or comfort level for the one or more passengers. Another aspect of the method can include determining that the transportation request is for transport of at least two passengers. Another aspect of the method can include blending passenger profiles associated with the at least two passengers to form a group profile. Additionally, the one or more ride and performance dynamics for the passenger transport can be adjusted in response to the group profile. Another aspect of the method can include storing the adjusted one or more ride and performance dynamics for the passenger transport upon arrival at the destination. Another aspect of the method can include associating the stored ride and performance dynamics with the at least one passenger profile. Another aspect of the method can include associating an environmental and/or infrastructure condition with the stored ride and performance dynamics.

In another exemplary embodiment, a system for adjusting ride and/or performance dynamics of a passenger transport is disclosed herein. The system includes one or more passenger transports in which each passenger transport includes a memory and processor and in which the processor is operable to receive a transportation request. The processor is further operable to assign a passenger transport to fulfill the transportation request. The processor is further operable to receive at least one passenger profile, wherein the at least one passenger profile includes preferred ride and performance dynamics for a passenger. The processor is further operable to adjust one or more ride and performance dynamics for the passenger transport in response to the received at least one passenger profile. The processor is further operable to transport one or more passengers associated with the transportation request to a destination.

In yet another exemplary embodiment a computer readable storage medium for adjusting ride and/or performance dynamics of a passenger transport is disclosed herein. The computer readable storage medium includes receiving a transportation request. The computer readable storage medium further includes assigning a passenger transport to fulfill the transportation request. The computer readable storage medium further includes receiving at least one passenger profile, wherein the at least one passenger profile includes preferred ride and performance dynamics for a passenger. The computer readable storage medium further includes adjusting one or more ride and performance dynamics for the passenger transport in response to the received at least one passenger profile. The computer readable storage medium further includes transporting one or more passengers associated with the transportation request to a destination.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts an interaction between one or more mobile devices and a rideshare/passenger transport according to one or more embodiments;

FIG. 4 depicts a flow diagram of a method for adjusting ride and/or performance dynamics of a passenger transport according to one or more embodiments; and

FIG. 5 depicts a flow diagram of a method for adjusting ride and/or performance dynamics of a passenger transport according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

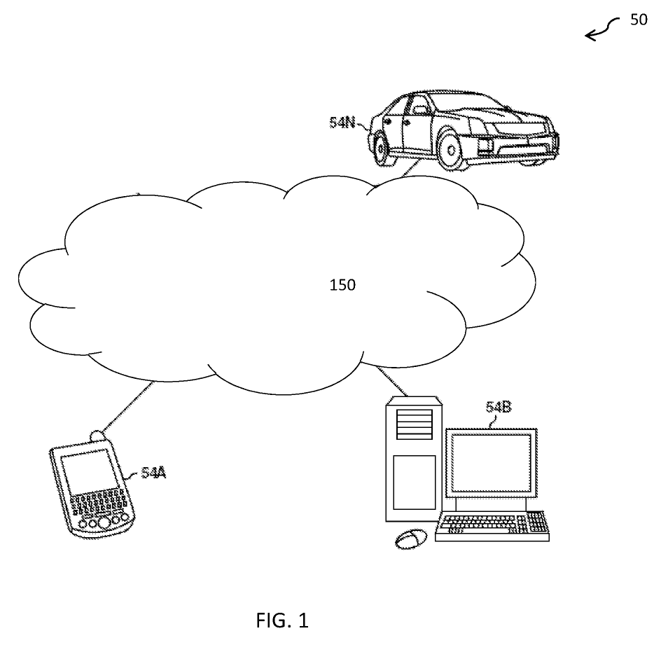

In accordance with an exemplary embodiment, FIG. 1 illustrates a computing environment 50 associated with a system for adjusting ride and/or performance dynamics of a passenger transport. As shown, computing environment 50 comprises one or more computing devices, for example, a personal digital assistant (PDA) or a cellular telephone (mobile device) 54A, a server 54B, and/or an automobile onboard computer system 54N, which are connected via network 150. The one or more computing devices can communicate with one another using network 150.

Network 150 can be, for example, a cellular network, a local area network (LAN), a wide area network (WAN), such as the Internet, a dedicated short range communications network (for example, V2V communication (vehicle-to-vehicle), V2X communication (i.e., vehicle-to-everything), V2I communication (vehicle-to-infrastructure), and V2P communication (vehicle-to-pedestrian)), or any combination thereof, and may include wired, wireless, fiber optic, or any other connection. Network 150 can be any combination of connections and protocols that will support communication between mobile device 54A, server 54B, and/or vehicle on-board computer system 54N, respectively.

The mobile device 54A and the vehicle associated with the vehicle on-board computer system 54N can include a GPS transmitter/receiver (not shown) which is operable for receiving location signals from the plurality of GPS satellites (not shown) that provide signals representative of a location for each of the mobile resources, respectively. In addition to the GPS transmitter/receiver, the mobile device 54A and the vehicle associated with the vehicle on-board computer system 54N may include a navigation processing system that can be arranged to communicate with a server 54B through the network 150. Accordingly, the mobile device 54A and the vehicle associated with the vehicle on-board computer system 54N are able to determine location information and transmit that location information to the server 54B.

The vehicle on-board computer system 54N may also include one or more sensors (e.g., radar, LIDAR, cameras (internal and external), weather, longitudinal acceleration, gesture recognition, motion, eye gaze tracking or the like). The vehicle on-board computer system 54N may also include one or more microphones and a speech processing application.

Additional signals sent and received may include data, communication, and/or other propagated signals. Further, it should be noted that the functions of transmitter and receiver can be combined into a signal transceiver.

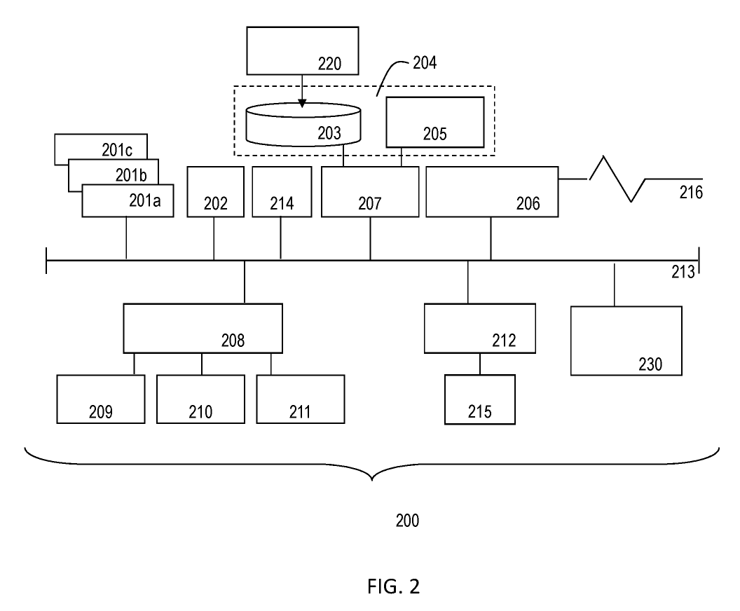

In accordance with an exemplary embodiment, FIG. 2 illustrates a processing system 200 for implementing the teachings herein. The processing system 200 can form at least a portion of the one or more computing devices, such as mobile device 54A, server 54B, and/or vehicle on-board computer system 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. A network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

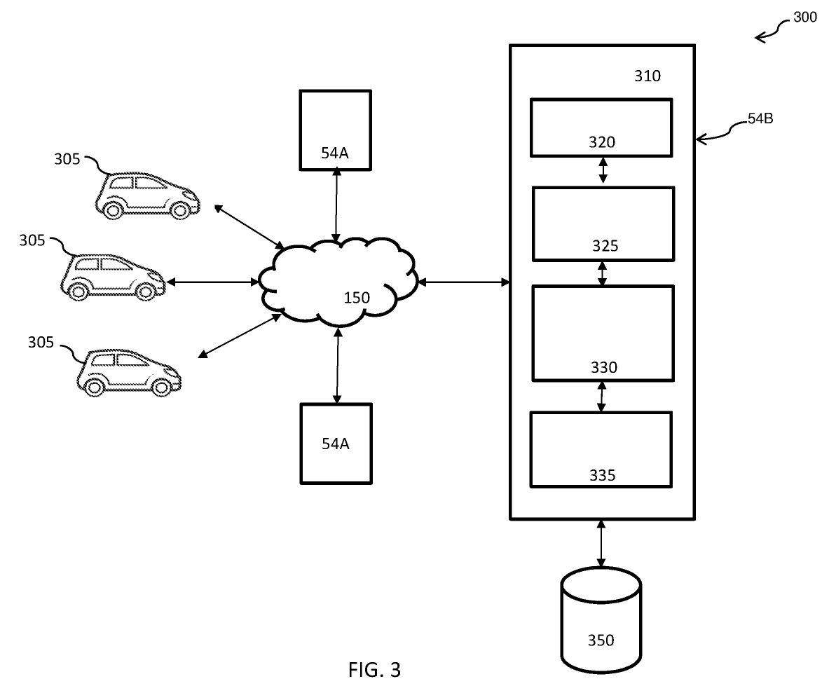

FIG. 3 depicts an interaction 300 between one or more mobile devices 54A and one or more rideshare/passenger transports 305 according to one or more embodiments. A would-be passenger (e.g., rideshare, taxi or the like) can utilize a passenger transport application (not shown) stored on mobile device 54A to interact with server 54B in order to allow the would-be passenger to request passenger transport (trip) to a destination via rideshare/passenger transport 305. The server 54B can include a transport engine 310, which can be used to facilitate the transportation of one or more passengers using one or more passenger transports. The server 54B can also include a datastore 350, which can store information related to the transport of the one or more passengers, for example, passenger profiles (i.e., information related to the passenger (e.g., payment information, identification information, personal driving dynamics or the like)), passenger transport type, passenger transport capacity, or the like.

The transport engine 310 can include, for example, a mapping engine 320, a routing engine 325, a transport availability engine 330 and a profile blending engine 335. The mapping engine 320, routing engine 325, transport availability engine 330 and profile blending engine 335 can be used to transport one or more passengers from a pickup location to a destination location. Each passenger transport can also include a mapping engine, a routing engine, a transport availability engine and a profile blending engine (not shown). The passenger transport application can also include a datastore to store one or more passenger profiles.

The personal driving dynamics portion of the passenger profile can contain a variety of factors related to desired ride and performance aspects for travel within the passenger transport. For example, factors can include vehicle acceleration/deceleration, ride (e.g., comfort, suspension, etc.), turning rates, pull out gaps, following distances, sound level, lane choice or the like. The passenger can adjust one or more of the factors as well as simply indicate like/dislike in order to tailor a driving experience, i.e., how the passenger desires the passenger transport to operate. If the passenger does not desire or does not know how to adjust the factors related to desired ride and performance, the passenger can select a drive setting from a group of drive settings to be associated with the passenger profile. A drive setting can be an established setting related to a group of factors that can be associated with desired ride and performance aspects for travel within the passenger transport. The drive settings can be, for example, normal, aggressive, relaxed or the like.

Transport to a destination from a pickup location can be requested via the passenger transport application. If a passenger has indicated personal driving dynamics within an associated passenger profile, the personal driving dynamics information can be sent to a passenger transport (e.g., rideshare/passenger transport 305) when the passenger transport is assigned to fulfill the request for transport to the destination. If the passenger has not indicated personal driving dynamics within the associated passenger profile, but has selected a drive setting, the drive setting can be sent to the passenger transport. If the passenger has not indicated personal driving dynamics or selected a drive setting, the passenger transport can operate in accordance with a baseline setting. The passenger profile, drive setting or baseline setting can be transmitted to the passenger transport via mobile device 54A or server 54B, which can be associated with a cloud platform.

During transport to the destination, the passenger transport can receive input from the passenger regarding ride anxiety, drive comfort and desired performance, as well as monitor the passenger section of the passenger transport to assess passenger comfort and acceptance of current ride and performance aspects of the passenger transport. For example, the passenger transport can receive passenger input via user interface, which could be simple one button activation within the passenger transport indicating that the last maneuver exceeded or met user expectations or via an adjustment/selection menu associated with the passenger transport application. The passenger transport can also use a variety of sensors within the passenger transport to monitor the passenger section to determine ride anxiety, drive comfort and desired performance. For example, the passenger transport can include one or more cameras, gesture tracking software, motion sensors, eye gaze and head tracking software, microphones, to acquire passenger comfort feedback data during transport. The passenger transport can also note weather occurring at the time input and/or monitoring occurs, which can be stored with an associated set of passenger preferred ride and performance aspects. For example, a passenger that is not used to snow can have high anxiety when transport occurs during a snow event. The passenger transport dynamics related to snow for the passenger can be stored by the mobile device 54A and/or server 54B. Accordingly, a passenger profile can include a plurality of ride and/or performance dynamics settings dependent on determined environmental and/or infrastructure conditions.

Accordingly, the passenger transport can learn a passenger's preferred ride and performance aspects and adjust aspects of the passenger transport dynamics to optimize a driving experience for the passenger in real-time. Adjustments to passenger dynamics of the passenger transport can be in response to input from the passenger and/or monitoring levels of anxiety and comfort of the passenger in light of passenger transport operation related to acceleration/deceleration, ride (e.g., comfort, suspension, etc.), turning rates, pull out gaps, following distances, sound level, lane choice or the like. Adjustments can occur via an iterative process.

When operating in a rideshare scenario, i.e., multiple passengers (group) riding in the passenger transport, each passenger can have preferred ride and performance aspects for travel within the passenger transport. To account for the preferences of multiple passengers, the passenger transport can compensate for each passenger profile associated with the multiple passengers by blending and/or weighting the multiple passenger profiles to form a group profile. The group profile can be used by the passenger transport to provide an optimized shared driving experience for the group. The passenger transport can also receive the group profile from the server 54B.

The blending of profiles for passengers within a group can be accomplished using a variety of linear or non-linear functions. The functions can use a plurality of inputs to determine a group profile. For example, inputs can be based on categories related to braking onset distance, brake rate curve, acceleration onset, acceleration rate curve, ride stiffness, roll rate, roll limit, yaw rate, pitch rate, pitch limit, forward vehicle closing rate, forward vehicle brake onset, pedestrian clearance, pedestrian brake onset, pedestrian closing rate, or the like. The inputs can be represented in a matrix format, e.g., (X₁, X₂ . . . Xₙ). A sensitivity matrix can be created (S₁, S₂ . . . Sₙ) by calculating a passenger sensitivity for each category using, for example, the equation

$${S}_{x} = {( \frac{\sum {( X - μ )}^{2}}{N} )}^{1 / 2}$$

collected for N samples for each Xₙ(1−N). The passenger sensitivities for each passenger within the group [e.g., consisting of z riders (R₁ . . . R_{z})] for all preference categories S′₁₋ₙ=(S_{1-z}−S_{zmin})/(S_{zmax}−S_{zmin}) can be normalized. The normalized passenger sensitivities can be averaged to create the group profile. The group profile can be updated as riders retune their preferences during a group rideshare experience.

Accordingly, blending of passenger profiles within a group can be an iterative process. When the passenger sensitivities for one or more passengers within the group are determined to be outside a predetermined range of the group profile, e.g., above one sigma of the group sensitivity, the one or more passengers can be removed from the group and assigned to another rideshare group better fitting the one or more passenger's sensitivities.

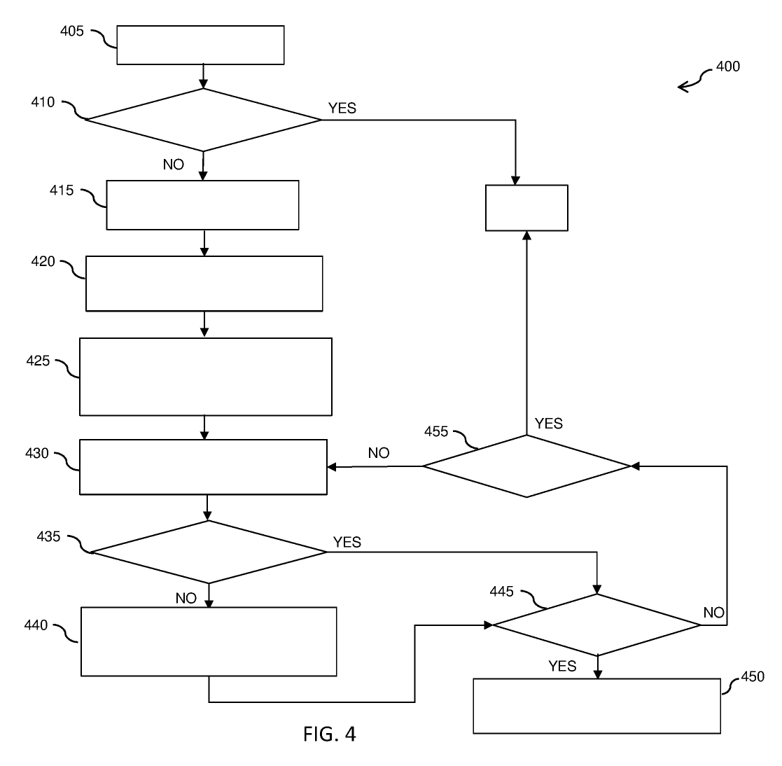

In accordance with an exemplary embodiment, FIG. 4 depicts a flow diagram of a method 400 for adjusting ride and/or performance dynamics of a passenger transport according to one or more embodiments. At block 405, a server, for example server 54B, receives a transportation request for transportation to a destination from a would-be passenger, via a passenger transport application associated with a mobile device, for example, mobile device 54A. At block 410, the server 54B can determine if the transportation request is for a single passenger or multiple passengers. If the transportation request is for multiple passengers, the method proceeds to block 505 of method 500, which is discussed herein.

If the transportation request is for a single passenger, the method 400 proceeds to block 415, where the server 54B can assign a passenger transport (e.g., taxi, autonomous vehicle, rideshare vehicle, etc.) to fulfill the transport request. At block 420, a passenger profile, a drive setting or a baseline setting associated with the passenger can be sent to the passenger transport. At block 425, the passenger transport can adjust ride and performance dynamics of the passenger transport based on the received passenger profile, drive setting or baseline setting prior to passenger pickup or during passenger pickup.

At block 430, during transport, the passenger transport can receive input regarding passenger comfort from the passenger using, for example, the passenger transport application, an input console, a button within the passenger transport, a microphone or the like, and/or by monitoring the passenger via one or more sensors associated with the passenger transport. At block 435, the method 400 can determine if the passenger is comfortable using the received input and/or monitoring of the passenger. If it is determined that the passenger is not comfortable, method 400 proceeds to block 440 where ride and/or performance dynamics for the passenger transport can be adjusted in an attempt to make the passenger more comfortable. For example, the braking distance to another vehicle can be increased when the passenger transport is coming to a stop based on gestures made by the passenger during previous braking maneuvers. Method 400 will then proceed to block 445.

If it is determined that the passenger is comfortable, method 400 proceeds to block 445 where the method 400 can determine if the destination has been reached. If the destination has been reached, the method 400 proceeds to block 450 where the ride and performance dynamics for the passenger transport are stored and associated with the passenger, for example, in datastore 350. If the destination has not been reached, the method 400 proceeds to block 455 where the method determines whether additional passengers will be picked up before reaching the passenger's destination. If additional passengers will not be picked up, the method 400 returns to block 430. If additional passengers will be picked up, the method 400 proceeds to block 505 of method 500. Portions of method 400 can be performed by the passenger transport and/or server 54B/cloud platform.

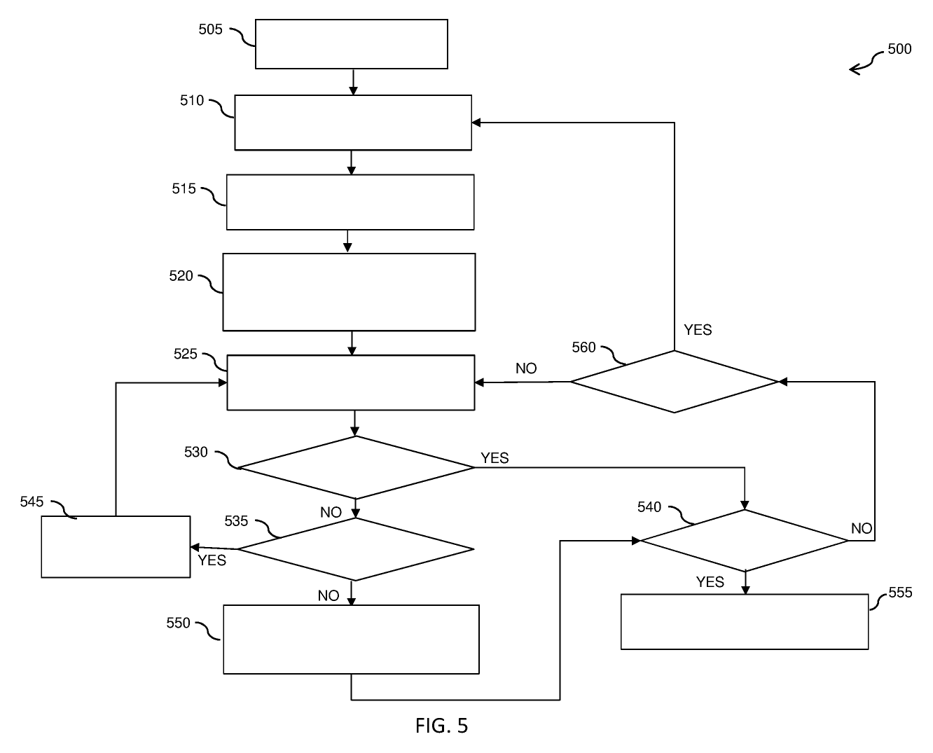

In accordance with an exemplary embodiment, FIG. 5 depicts a flow diagram of a method 500 for adjusting ride and/or performance dynamics of a passenger transport according to one or more embodiments. At block 505, a server, for example server 54B, can assign a passenger transport (e.g., taxi, autonomous vehicle, rideshare vehicle, etc.) to fulfill the transport request. At block 510, a group profile or a passenger profile, a drive setting or a baseline setting associated with the passenger to be added to the group profile, can be sent to the passenger transport. At block 515, the passenger transport can blend the passenger profile, drive setting or baseline setting to be added to the group profile. The passenger transport can also blend individual passenger profiles, drive settings or baseline settings to form a group profile.

At block 520, the passenger transport can adjust ride and performance aspects of the passenger transport based on the received group profile prior to passenger pickup or during passenger pickup for the group or passenger being added during group passenger transport. At block 525, during transport, the passenger transport can receive input regarding each passenger's comfort using, for example, the passenger transport application, an input console, a button within the passenger transport, a microphone or the like, and/or by monitoring the passenger via one or more sensors associated with the passenger transport. At block 530, the method 500 can determine if each passenger is comfortable using the received input and/or monitoring of the passengers. If each passenger is comfortable, the method 500 proceeds to block 540. If it is determined that a passenger within the group is not comfortable, method 500 proceeds to block 535, where a level of discomfort for the passenger is compared to a group norm to determine whether the level of discomfort exceeds the group norm by a predetermined threshold. For example, the predetermined threshold can be determined using a numerical indexing of passenger rating(s) in relation to comfort, anxiety, desired performance, etc., which can be used to a level at which one or more passengers should no longer be associated with a rideshare group. If the level of discomfort for the passenger exceeds the predetermined threshold, the method 500 proceeds to block 545, where the passenger is removed from a current rideshare group and assigned to another rideshare group that better fits the comfort level of the passenger.

If the level of discomfort for the passenger does not exceed the predetermined threshold, the method 500 proceeds to block 550, where ride and/or performance dynamics for the passenger transport can be adjusted in an attempt to make the passenger more comfortable. At block 540, the method 500 can determine if the destination has been reached. If the destination has been reached, the method 500 proceeds to block 555 where the ride and performance dynamics for the passenger transport are stored and associated with the group. If the destination has not been reached, the method 500 proceeds to block 560 where the method 500 can determine whether additional passengers will be picked up before reaching the destination. If additional passengers will not be picked up, the method 500 returns to block 525. If additional passengers will be picked up, the method 500 returns to block 510. Portions of method 500 can be performed by the passenger transport and/or server 54B/cloud platform.

Accordingly, the embodiments disclosed herein describe a system that allows a passenger or group of passengers to set and adjust autonomous vehicle performance dynamics (e.g., vehicle acceleration/deceleration, ride, turning rates, pull out gaps, following distances, sound level, lane choice, etc.) to optimize a comfort level during a personal or group travel experience. The autonomous vehicle and/or mobile device can monitor and/or receive input regarding anxiety/comfort limits for the passenger. The autonomous vehicle can learn and adjust the performance dynamics in response to the anxiety/comfort limits for the passenger using for example, a single button activation if the last maneuver exceeded or met user expectations, adjustments to presets and/or a menu via an application on the mobile device which can communicate with the autonomous vehicle, or verbal change requests.

The system can also blend/weight multiple passenger preferences to provide single reconciled set for a shared autonomous vehicle experience. The system also measures and displays the vehicle dynamic response characteristics for review, reference and readjustment by the passenger or group of passengers.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that the computing environment 50 that is associated with a system for adjusting ride and/or performance dynamics of a passenger transport can be implemented in a cloud computing environment, and passenger profiles and associated preferred ride and performance dynamics for the passenger can be stored locally and/or remotely, such as in the cloud computing environment.

Technical effects and benefits of the disclosed embodiments include, but are not limited to a tailored driving experience that allows the passenger to adjust the vehicle performance dynamics (acceleration/deceleration, turning rates) to optimize their personal experience; a mobile device that can measure vehicle dynamics characteristics storing them for reference and adjustment; a system optimizes and combines group preferences in shared driving experience; an autonomous vehicle that can record anxiety/comfort limits and warn the passenger for action; and application that allows passenger performance dynamics preferences to be transmitted to autonomous and non-autonomous vehicles in conjunction with a transport request; a transport system that can integrate crowd sourced passenger performance dynamics preferences; an autonomous vehicle that can adapt performance dynamics in response to environmental and infrastructure changes and passenger anxiety/comfort limits; an autonomous vehicle dynamics that can adapt performance dynamics in response to a health state for passengers; learning and adjusting autonomous vehicle response in real-time using a button activation to indicate that a last maneuver exceeded or met user expectations; and a feature that warns the passenger that they have exceeded legal road restrictions.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for adjusting ride and/or performance dynamics of a passenger transport, the method comprising:
receiving, by a processor, a transportation request;
assigning, by the processor, a passenger transport to fulfill the transportation request;
receiving, by the processor, at least one passenger profile, wherein the at least one passenger profile includes preferred ride and performance dynamics for a passenger;
adjusting, by the processor, one or more ride and performance dynamics for the passenger transport in response to the received at least one passenger profile; and
transporting, by the passenger transport, one or more passengers associated with the transportation request to a destination.

2. The method of claim 1, further comprising receiving input from the one or more passengers during transport to the destination and adjusting the one or more ride and performance dynamics for the passenger transport in response to the received input.

3. The method of claim 1, further comprising monitoring an anxiety and/or comfort level for the one or more passengers during transport to the destination and adjusting the one or more ride and performance dynamics for the passenger transport in response to the monitored anxiety and/or comfort level for the one or more passengers.

4. The method of claim 1, further comprising determining that the transportation request is for transport of at least two passengers.

5. The method of claim 4, further comprising blending passenger profiles associated with the at least two passengers to form a group profile.

6. The method of claim 5, wherein the one or more ride and performance dynamics for the passenger transport are adjusted in response to the group profile.

7. The method of claim 1 further comprising storing the adjusted one or more ride and performance dynamics for the passenger transport upon arrival at the destination.

8. The method of claim 7, further comprising associating the stored ride and performance dynamics with the at least one passenger profile.

9. The method of claim 7, further comprising associating an environmental and/or infrastructure condition with the stored ride and performance dynamics.

10. A system for adjusting ride and/or performance dynamics of a passenger transport, the system comprising:
one or more passenger transports, wherein each passenger transport comprises:
a memory; and
a processor coupled to the memory, wherein the processor is operable to:
receive a transportation request;
assign a passenger transport to fulfill the transportation request;
receive at least one passenger profile, wherein the at least one passenger profile includes preferred ride and performance dynamics for a passenger;
adjust one or more ride and performance dynamics for the passenger transport in response to the received at least one passenger profile; and
transport one or more passengers associated with the transportation request to a destination.

11. The system of claim 10, wherein the processor is further operable to receive input from the one or more passengers during transport to the destination and adjusting the one or more ride and performance dynamics for the passenger transport in response to the received input.

12. The system of claim 10, wherein the processor is further operable to monitor an anxiety and/or comfort level for the one or more passengers during transport to the destination and adjust the one or more ride and performance dynamics for the passenger transport in response to the monitored anxiety and/or comfort level for the one or more passengers.

13. The system of claim 10, wherein the processor is further operable to determine that the transportation request is for transport of at least two passengers.

14. The system of claim 13, wherein the processor is further operable to blend passenger profiles associated with the at least two passengers to form a group profile.

15. The system of claim 14, wherein the one or more ride and performance dynamics for the passenger transport are adjusted in response to the group profile.

16. The system of claim 10, wherein the adjusted one or more ride and performance dynamics for the passenger transport upon arrival at the destination is stored in the memory.

17. A non-transitory computer readable storage medium having program instructions embodied therewith, the program instructions readable by a processor to cause the processor to perform a method for adjusting ride and/or performance dynamics of a passenger transport comprising:
receive a transportation request;
assign a passenger transport to fulfill the transportation request;
receive at least one passenger profile, wherein the at least one passenger profile includes preferred ride and performance dynamics for a passenger;
adjust one or more ride and performance dynamics for the passenger transport in response to the received at least one passenger profile; and
transport one or more passengers associated with the transportation request to a destination.

18. The computer readable storage medium of claim 17, further comprising receiving input from the one or more passengers during transport to the destination and adjusting the one or more ride and performance dynamics for the passenger transport in response to the received input.

19. The computer readable storage medium of claim 17, further comprising monitoring an anxiety and/or comfort level for the one or more passengers during transport to the destination and adjusting the one or more ride and performance dynamics for the passenger transport in response to the monitored anxiety and/or comfort level for the one or more passengers.

20. The computer readable storage medium of claim 17, further comprising determining that the transportation request is for transport of at least two passengers and blending passenger profiles associated with the at least two passengers to form a group profile.
